(19) United States
(12) Patent Application Publication
(10) Pub. No.: US 2024/0400052 A1
(43) Pub. Date: Dec. 5, 2024

(54) VEHICLE CONTROL APPARATUS AND VEHICLE CONTROL METHOD

(71) Applicant: Mitsubishi Electric Corporation, Tokyo (JP)

(72) Inventors: Yusuke MATSUO, Tokyo (JP); Yuko OMAGARI, Tokyo (JP); Mizuho WAKABAYASHI, Tokyo (JP)

(73) Assignee: Mitsubishi Electric Corporation, Tokyo (JP)

(21) Appl. No.: 18/612,335

(22) Filed: Mar. 21, 2024

(30) Foreign Application Priority Data
May 29, 2023 (JP) 2023-087486

(51) Int. Cl. B60W 30/16; B60W 40/10

(52) U.S. Cl. CPC B60W 30/162; B60W 40/10; B60W 2520/06; B60W 2552/20; B60W 2554/804; B60W 2720/103

(57) ABSTRACT

To provide a vehicle control apparatus and a vehicle control method which performs acceleration and deceleration appropriately and can improve the riding comfort of traveling to the deceleration point, when the deceleration point exists ahead, after transiting to the diversion lane from the main lane. A vehicle control apparatus, when the diversion lane exists before the deceleration point, sets the target speed of the ego vehicle based on a speed command value, before the start point of transition driving to the diversion lane; and sets the target speed based on the speed command value, the travelling speed of the ego vehicle, a remaining distance from the start point of transition driving to the diversion lane to the deceleration point, and the deceleration point speed, after the start point of transition driving to the diversion lane.

### INCORPORATION BY REFERENCE

The disclosure of Japanese Patent Application No. 2023-087486 filed on May 29, 2023 including its specification, claims and drawings, is incorporated herein by reference in its entirety.

### BACKGROUND

The present disclosure relates to a vehicle control apparatus and a vehicle control method.

Previously, a vehicle control apparatus is in practical use that controls to maintain an inter-vehicle distance between the ego vehicle and other vehicle is performed when other vehicle exists in front of an ego vehicle, and travels at a constant speed according to a set speed command value when other vehicle does not exist in front of the ego vehicle. In addition, there is also known technology that performs a deceleration control at a point where deceleration should be performed, such as at a highway interchange.

In the technology of JP 3714014 B, when the ego vehicle approaches a deceleration node, and a manipulating direction of a direction indicator and a direction of the deceleration node coincide, the control of the inter-vehicle distance is interrupted.

### SUMMARY

In the conventional vehicle control apparatus, when only the ego vehicle transits to the diversion lane in the situation where the ego vehicle is following other vehicle of a travelling speed lower than a speed command value in a main lane, other vehicle is canceled from the tracking object and the ego vehicle accelerates to the speed command value. However, when a deceleration point exists after the diversion lane, the ego vehicle may decelerate immediately after acceleration depending on conditions, and riding comfort is deteriorated. On the other hand, if acceleration is not performed after transiting to the diversion lane, a traveling time to the deceleration point becomes long when a distance of the diversion lane to the deceleration point is long or when the travelling speed before transition is low, and riding comfort is deteriorated.

Then, the purpose of the present disclosure is to provide a vehicle control apparatus and a vehicle control method which performs acceleration and deceleration appropriately and can improve the riding comfort of traveling to the deceleration point, when the deceleration point exists ahead, after transiting to the diversion lane from the main lane.

A vehicle control apparatus according to the present disclosure, including:
an information acquisition unit that acquires a traveling state of an ego vehicle, road information around the ego vehicle, and information on other vehicle around the ego vehicle;
a target travel route setting unit that sets a target travel route of the ego vehicle;
a deceleration point setting unit that sets a deceleration point which is a point where a speed at which the ego vehicle should travel is less than a present travelling speed of the ego vehicle, on the target travel route, based on the traveling state, the target travel route, and the road information, and sets a deceleration point speed which is a speed at which the ego vehicle should travel at the deceleration point;
a deceleration start point setting unit that sets a deceleration start point which is a point where a deceleration of the ego vehicle is started, between a present position of the ego vehicle and the deceleration point, on the target travel route;
a target traveling state setting unit that sets a target speed; and a vehicle control unit that controls the ego vehicle based on the target speed,
wherein, when a diversion lane which diverges from a main lane before the deceleration point exists on the target travel route, the deceleration start point setting unit sets the deceleration start point, after a start point of transition driving from the main lane to the diversion lane, and
wherein, when the diversion lane exists before the deceleration point, the target traveling state setting unit sets the target speed of the ego vehicle based on a speed command value, before the start point of transition driving to the diversion lane;
the target traveling state setting unit sets the target speed based on the speed command value, the present travelling speed of the ego vehicle, a remaining distance from the start point of transition driving to the diversion lane, to the deceleration point, and the deceleration point speed, after the start point of transition driving to the diversion lane; and
when other vehicle exists within a determination range in front of the ego vehicle, the target traveling state setting unit corrects the target speed according to the travelling speed of other vehicle.

A vehicle control method according to the present disclosure that makes an arithmetic processor perform each following step, the vehicle control method including:
an information acquisition step of acquiring a traveling state of an ego vehicle, road information around the ego vehicle, and information on other vehicle around the ego vehicle;
a target travel route setting step of setting a target travel route of the ego vehicle;
a deceleration point setting step of setting a deceleration point which is a point where a speed at which the ego vehicle should travel is less than a present travelling speed of the ego vehicle, on the target travel route, based on the traveling state, the target travel route, and the road information, and setting a deceleration point speed which is a speed at which the ego vehicle should travel at the deceleration point;
a deceleration start point setting step of setting a deceleration start point which is a point where a deceleration of the ego vehicle is started, between a present position of the ego vehicle and the deceleration point, on the target travel route; a target traveling state setting step of setting a target speed; and
a vehicle control step of controlling the ego vehicle based on the target speed,
wherein, in the deceleration start point setting step, when a diversion lane which diverges from a main lane before the deceleration point exists on the target travel route, setting the deceleration start point after a start point of transition driving from the main lane to the diversion lane, and
wherein, in the traveling state setting step, when the diversion lane exists before the deceleration point, setting the target speed of the ego vehicle based on a speed command value, before the start point of transition driving to the diversion lane;
setting the target speed based on the speed command value, the present travelling speed of the ego vehicle, a remaining distance from the start point of to the diversion lane, to the deceleration point, and the deceleration point speed, after the start point of transition driving to the diversion lane; and
when other vehicle exists within a determination range in front of the ego vehicle, correcting the target speed according to the travelling speed of other vehicle.

According to the vehicle control apparatus and the vehicle control method of the present disclosure, even when only the ego vehicle transits to the diversion lane in the situation where the ego vehicle is following other vehicle of the travelling speed lower than the speed command value in the main lane, the target speed is set based on the speed command value, the present travelling speed of the ego vehicle, the remaining distance from the start point of transition driving to the deceleration point, and the deceleration point speed. Accordingly, acceleration and deceleration can be performed appropriately according to the status of the diversion lane, and the status of the ego vehicle, and riding comfort of traveling to the deceleration point can be improved.

### BRIEF DESCRIPTION OF THE DRAWINGS

FIG. 1 is a schematic block diagram of the vehicle control apparatus and the vehicle control system according to Embodiment 1;

FIG. 2 is a schematic hardware configuration diagram of the vehicle control apparatus according to Embodiment 1;

FIG. 3 is a flowchart for explaining schematic processing of the vehicle control apparatus according to Embodiment 1;

FIG. 4 is a figure for explaining setting of the target speed when the prediction traveling time is greater than or equal to the determination time, according to Embodiment 1;

FIG. 5 is a figure for explaining setting of the target speed when the prediction traveling time is less than the determination time, according to Embodiment 1; and

FIG. 6 is a figure for explaining setting of the target speed when the prediction traveling time is less than the determination time, according to Embodiment 2.

### DETAILED DESCRIPTION OF THE EMBODIMENTS

### 1. Embodiment 1

The vehicle control apparatus 50 according to Embodiment 1 will be explained with reference to drawings. In the present embodiment, the vehicle control apparatus 50 is provided in the ego vehicle.

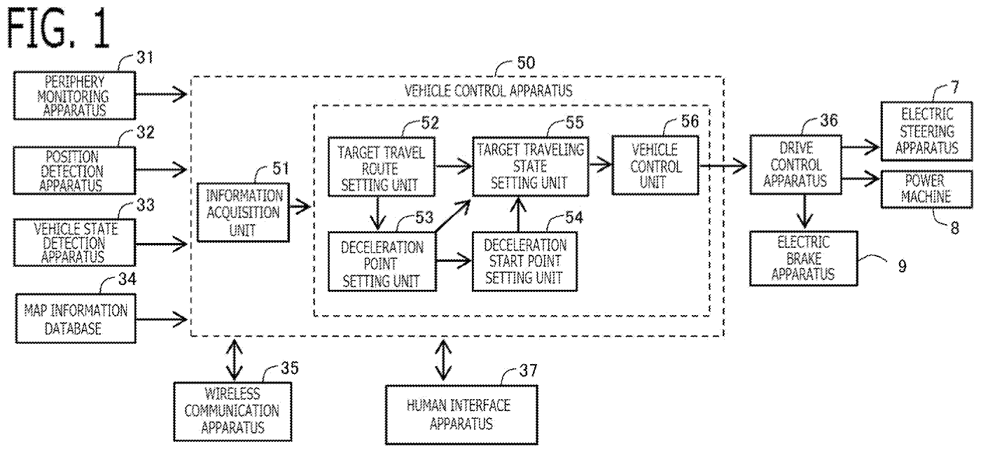

As shown in FIG. 1, the ego vehicle is provided with a periphery monitoring apparatus 31, a position detection apparatus 32, a vehicle state detection apparatus 33, a map information database 34, a wireless communication apparatus 35, a vehicle control apparatus 50, a drive control apparatus 36, a power machine 8, an electric steering apparatus 7, an electric brake apparatus 9, a human interface apparatus 37, and the like.

The periphery monitoring apparatus 31 is apparatus which monitor the periphery of vehicle, such as a camera and a radar. As the radar, a millimeter wave radar, a laser radar, an ultrasonic radar, and the like are used. The wireless communication apparatus 35 performs a wireless communication with a base station, using the wireless communication standard of cellular communication system, such as 4G and 5G.

The position detecting apparatus 32 is an apparatus which detects the current position (latitude, longitude, altitude) of the ego vehicle, and a GPS antenna which receives the signal outputted from satellites, such as GNSS (Global Navigation Satellite System), is used. For detection of the present position of the ego vehicle, various kinds of methods, such as the method using the traveling lane identification number of the ego vehicle, the map matching method, the dead reckoning method, and the method using the detection information around the ego vehicle, may be used.

In the map information database 34, road information, such as a road shape (for example, a lane number, a position of each lane, a shape of each lane, a type of each lane, a road type, a limit speed, and the like), a road sign (a limit speed sign and its limit speed, a stop sign, and the like), a tollgate (an entrance position of tollgate, a passing speed of tollgate, and the like), and a traffic signal, is stored. The map information database 34 is mainly constituted of a storage apparatus. The map information database 34 may be provided in a server outside the vehicle connected to the network, and the vehicle control apparatus 50 may acquire required road information from the server outside the vehicle via the wireless communication apparatus 35.

As the drive control apparatus 36, a power controller, a brake controller, an automatic steering controller, a light controller, and the like are provided. The power controller controls an output of a power machine 8, such as an internal combustion engine and a motor. The brake controller controls a brake operation of the electric brake apparatus 9. The automatic steering controller controls the electric steering apparatus 7. The light controller controls a direction indicator, a hazard lamp, and the like.

The vehicle condition detection apparatus 33 is a detection apparatus which detects an ego vehicle state which is a driving state and a traveling state of the ego vehicle. In the present embodiment, the vehicle state detection apparatus 33 detects a speed, an acceleration, a yaw rate, a steering angle, a lateral acceleration and the like of the ego vehicle, as the traveling state of the ego vehicle. For example, as the vehicle state detection apparatus 33, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 33, an accelerator position sensor, a brake position sensor, a steering angle sensor (handle angle sensor), a steering torque sensor, a direction indicator position switch, and the like are provided.

The human interface apparatus 37 is an apparatus which receives input of the driver or transmits information to the driver, such as a loudspeaker, a display screen, an input device, and the like.

### 1-1. Vehicle Control Apparatus 50

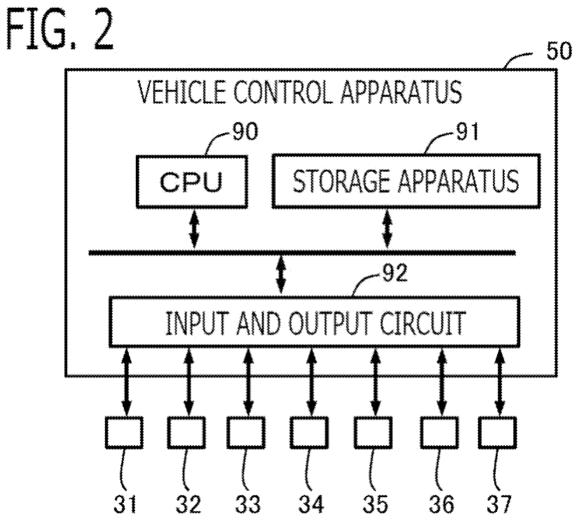

The vehicle control apparatus 50 is provided with processing units of an information acquisition unit 51, a target travel route setting unit 52, a deceleration point setting unit 53, a deceleration start point setting unit 54, a target traveling state setting unit 55, a vehicle control unit 56, and the like. Each processing of the vehicle control apparatus 50 is realized by processing circuits provided in the vehicle control apparatus 50. As shown in FIG. 2, specifically, the vehicle control apparatus 50 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle state detection apparatus 33, the map information database 34, the wireless communication apparatus 35, the drive control apparatus 36, and the human interface apparatus 37, and communicates with these devices.

Then, the arithmetic processor 90 runs software items (programs) stored in the storage apparatus 91 and collaborates with other hardware devices in the vehicle control apparatus 50, such as the storage apparatus 91, and the input and output circuit 92, so that the respective processings of the processing units 51 to 56 provided in the vehicle control apparatus 50 are realized. Setting data, such as a determination time tₜₕ, utilized in the processing units 51 to 56 are stored in the storage apparatus 91, such as EEPROM.

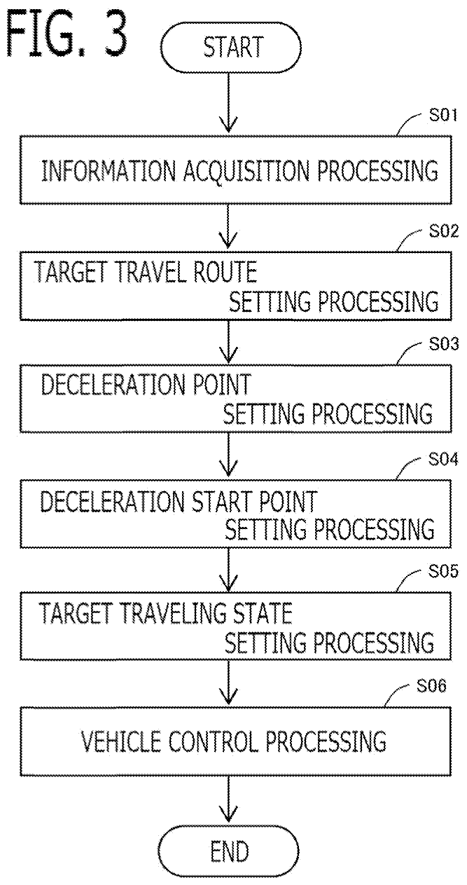

Hereinafter, each processing of the vehicle control apparatus 50 will be explained in detail, referring to the flowchart of FIG. 3. Processing of the flowchart of FIG. 3 is executed at every predetermined calculation period, for example. The processing of unnecessary step at the execution time is skipped appropriately.

### 1-1-1. Information Acquisition Unit 51

In the step S01 of FIG. 3, the information acquisition unit 51 acquires a traveling state of the ego vehicle, road information around the ego vehicle, and information on other vehicle around the ego vehicle.

The information acquisition unit 51 acquires the traveling state of the ego vehicle. In the present embodiment, the information acquisition unit 51 acquires a position, a moving direction, a speed, an acceleration, and the like of the ego vehicle, based on position information of the ego vehicle acquired from the position detection apparatus 32, and the ego vehicle state acquired from the vehicle state detection apparatus 33.

The information acquisition unit 51 acquires road information around the ego vehicle from the map information database 34, based on the position information of the ego vehicle acquired from the position detection apparatus 32. The acquired road information includes the road shape (for example, the lane number, the position of each lane, the shape of each lane, the type of each lane, the road type, the limit speed, and the like), a road sign (the limit speed sign and its limit speed, the stop sign, and the like), the tollgate (the entrance position of tollgate, the passing speed of tollgate, and the like), and the traffic signal, and the like. The shape of each lane includes a center position of lane, a width of lane, a curvature of lane, and the like. The shape of lane is set at each point along the longitudinal direction of the lane. The type of each lane includes a main lane, a diversion lane which diverges from the main lane, and the like. The shape of lane includes a start position of the diversion lane, an end position of the diversion lane, and a length of the diversion lane. The diversion lane may include a deceleration lane for decelerating gradually after the diversion.

The information acquisition unit 51 detects a shape and a type of a lane marking and the like of the road, based on the detection information on the lane marking, such as a white line and a road shoulder, acquired from the periphery monitoring apparatus 31; and determines the shape and the position of each lane, the lane number, the type of each lane, and the like, based on the detected shape and the detected type of the lane marking of the road. The shape of each lane includes the center position of lane, the width of lane, the curvature of lane, and the like. The type of each lane includes the main lane, the diversion lane, and the like.

The information acquisition unit 51 acquires information on the road sign, the traffic signal, and the tollgate, based on the detection information acquired from the periphery monitoring apparatus 31. The information acquisition unit 51 may acquire the present state of the traffic signal and the like from the outside via the wireless communication.

The information acquisition unit 51 acquires information on other vehicle around the ego vehicle. In the present embodiment, the information acquisition unit 51 acquires a position, a moving direction, a speed, an acceleration, and the like of other vehicle, based on detection information acquired from the periphery monitoring apparatus 31, and position information of the ego vehicle acquired from the position detection apparatus 32. The information acquisition unit 51 also acquires information of an obstacle, a pedestrian, a traffic regulation such as lane regulation, and the like, other than other vehicle.

The information acquisition unit 51 may acquire the traveling state of other vehicle (the position, the moving direction, the speed, and the like of other vehicle), the road information (the lane information and the like), and the traffic information (the obstacle, the congestion degree, and the like) around the ego vehicle, from the outside of the ego vehicle by communication. For example, the information acquisition unit 51 may acquire the movement information on other vehicle, and the road information and the traffic information around the ego vehicle, from other vehicle or the server to which other vehicle uploaded information, by the wireless communication and the like. The information acquisition unit 51 may acquire the traveling state of other vehicle, the road information, the traffic information, and the like in a monitor area, from a roadside machine, such as a camera, which monitors the condition of the road, and the like, by the wireless communication and the like.

The information acquisition unit 51 acquires the lane information corresponding to a lane where the ego vehicle is traveling, based on the position of the ego vehicle. The information acquisition unit 51 acquires the lane information corresponding to a lane where each other vehicle is traveling, based on the position of each other vehicle. The acquired lane information includes the shape, the position, and the type of lane and the lane information of the peripheral lane.

### 1-1-2. Target Travel Route Setting Unit 52

In the step S02 of FIG. 3, the target travel route setting unit 52 sets a target travel route of the ego vehicle. For example, the target travel route setting unit 52 sets the target travel route from the present position of the ego vehicle to a target point using road information. Since various well-known methods are used for setting of the target travel route, explanation is omitted. In the target travel route, a target lane where the ego vehicle travels, and a lane change position are set. For example, when moving from the main lane to the diversion lane, a range to travel in the main lane, a position to change lanes from the main lane to the diversion lane, a range to travel in the diversion lane, and the like are set.

### 1-1-3. Deceleration Point Setting Unit 53

In the step S03 of FIG. 3, the deceleration point setting unit 53 sets a deceleration point which is a point where a speed at which the ego vehicle should travel is less than the present travelling speed v₀ of the ego vehicle, on the target travel route, based on the traveling state of the ego vehicle, the target travel route, and the road information; and sets a deceleration point speed v₂ which is a speed at which the ego vehicle should travel at the deceleration point.

The deceleration point is a point where a speed at which the ego vehicle should travel switches. The deceleration point setting unit 53 sets the deceleration point, based on at least one of a switching point of a limit speed, a switching point of a road type, and a switching point of a speed due to a change of road curvature.

For example, the deceleration point setting unit 53 sets, as the deceleration point, a start position of a lane interval with the limit speed lower than the limit speed of the present traveling lane, on the target travel route; and sets the deceleration point speed v₂, based on the decreased limit speed.

The deceleration point setting unit 53 sets, as the deceleration point, a start position of the road type with the limit speed lower than the limit speed of the road type of the present traveling lane, on the target travel route; and sets the deceleration point speed v₂, based on the decreased limit speed.

The deceleration point setting unit 53 sets, as the deceleration point, a start position of a curve interval on the target travel route; and sets the deceleration point speed v₂ based on a limit speed due to the road curvature of the curve interval. For example, the limit speed due to the road curvature is calculated by √ (limit value of lateral acceleration/curvature). When a speed command value vₛₑₜ or the present travelling speed v₀ of the ego vehicle is less than the limit speed due to the road curvature, the deceleration point and the deceleration point speed v₂ may not be set. The limit value of lateral acceleration is preliminarily set considering riding comfort and vehicle performance.

When a tollgate which requires deceleration exists on the target travel route, the deceleration point setting unit 53 sets an entrance of the tollgate as the deceleration point, and sets a passing speed of the tollgate as the deceleration point speed v₂. The tollgate which requires deceleration includes the tollgate where toll is automatically paid without stopping by wireless communication with onboard equipment (for example, ETC (Electronic Toll Collection System)). When the passing speed of the tollgate is specified, its passing speed (for example, 20 km/h) is set as the deceleration point speed v₂. The tollgate which requires deceleration includes the tollgate where toll is paid to a payment machine or staff, or a traffic ticket is received after stopping. When the vehicle stop is specified, the deceleration point speed v₂ is set to 0 km/h. Not only the tollgate of road, but also various tollgates, such as a tollgate of parking place and a tollgate of facility, may be included.

When the stop sign or the red light is detected on the target travel route, the deceleration point setting unit 53 sets a position before a stop position of a stop line or a front vehicle as the deceleration point, and sets the deceleration point speed v₂ to 0 km/h.

When a stopping vehicle is detected in front of the ego vehicle on the target travel route, the deceleration point setting unit 53 sets a position before the stopping vehicle (for example, position 5 meter before the stopping vehicle) as the deceleration point, and sets the deceleration point speed v₂ to 0 km/h. When there is the obstacle, the pedestrian, or the like, other than the front vehicle, a position which requires deceleration or stop may be set as the deceleration point.

When a plurality of deceleration points are set on the target travel route, the deceleration point setting unit 53 sets the deceleration point closest to the ego vehicle as the final deceleration point. When the deceleration point is not set on the target travel route, the deceleration point setting unit 53 determines that there is no deceleration point, and deceleration is not performed.

### 1-1-4. Deceleration Start Point Setting Unit 54

In the step S04 of FIG. 3, the deceleration start point setting unit 54 sets a deceleration start point which is a point where a deceleration of the ego vehicle is started, between the present position of the ego vehicle and the deceleration point, on the target travel route.

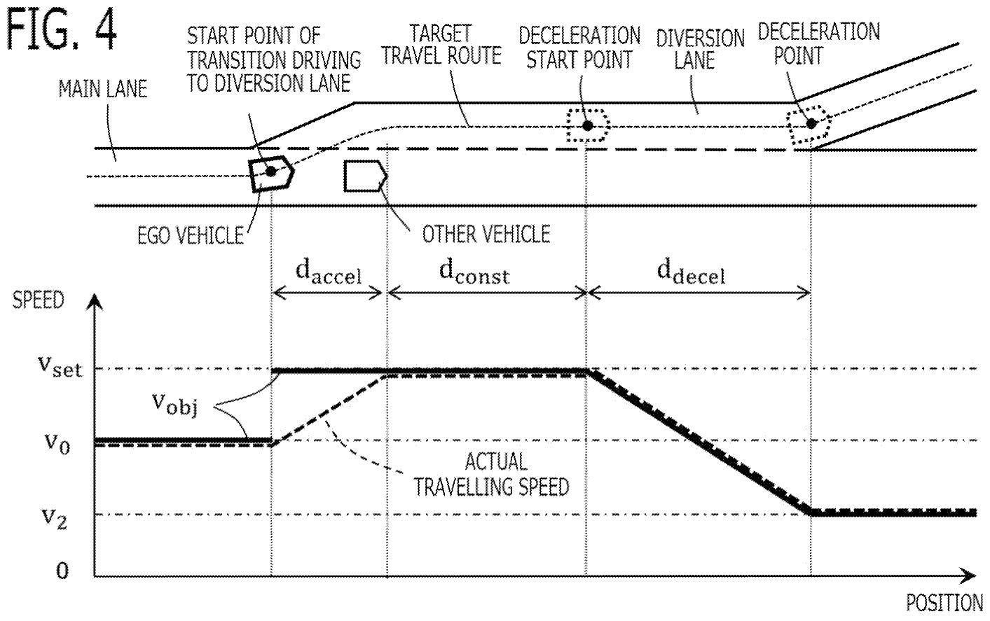

As shown in FIG. 4, when the diversion lane which diverges from the main lane before the deceleration point exists on the target travel route, the deceleration start point setting unit 54 sets the deceleration start point after a start point of transition driving from the main lane to the diversion lane.

For example, the deceleration start point setting unit 54 calculates a deceleration distance d_{decel} required to decelerate from the speed command value vₛₑₜ to the deceleration point speed v₂, and sets the deceleration start point to a position before the deceleration point by the deceleration distance d_{decel}. As shown in the next equation, the deceleration start point setting unit 54 calculates the deceleration distance d_{decel}, based on the speed command value vₛₑₜ, the deceleration point speed v₂, and a realizable deceleration a_{decel}. The realizable deceleration a_{decel} is preliminarily set considering vehicle performance and riding comfort. The speed command value vₛₑₜ is upper-limited by a speed obtained by adding a prescribed margin to the limit speed of the diversion lane, considering the limit speed of the diversion lane, a sensor error, and the like.

$$[ Math . 1 ]$$

$${d}_{decel} = \frac{{v}_{2}^{2} - {v}_{set}^{2}}{2 {a}_{decel}} \qquad ( 1 )$$

In the present disclosure, the deceleration means negative acceleration and is a negative value.

The deceleration distance d_{decel} may be decreased so that the deceleration start point is fallen within a range of the diversion lane.

### 1-1-5. Target Traveling State Setting Unit 55

In the step S05 of FIG. 3, the target traveling state setting unit 55 sets a target speed. When the diversion lane exists before the deceleration point, the target traveling state setting unit 55 sets the target speed v_{obj} of the ego vehicle based on the speed command value vₛₑₜ, before the start point of transition driving to the diversion lane. When other vehicle exists within a determination range in front of the ego vehicle, the target traveling state setting unit 55 corrects the target speed v_{obj} according to the travelling speed of other vehicle.

For example, when other vehicle exists within the determination range in front of the ego vehicle, the target traveling state setting unit 55 sets the target speed v_{obj} to a speed according to the travelling speed of other vehicle as to follow other vehicle with an inter-vehicle distance. When other vehicle does not exist within the determination range in front of the ego vehicle, the target traveling state setting unit 55 sets the target speed v_{obj} to the speed command value vₛₑₜ.

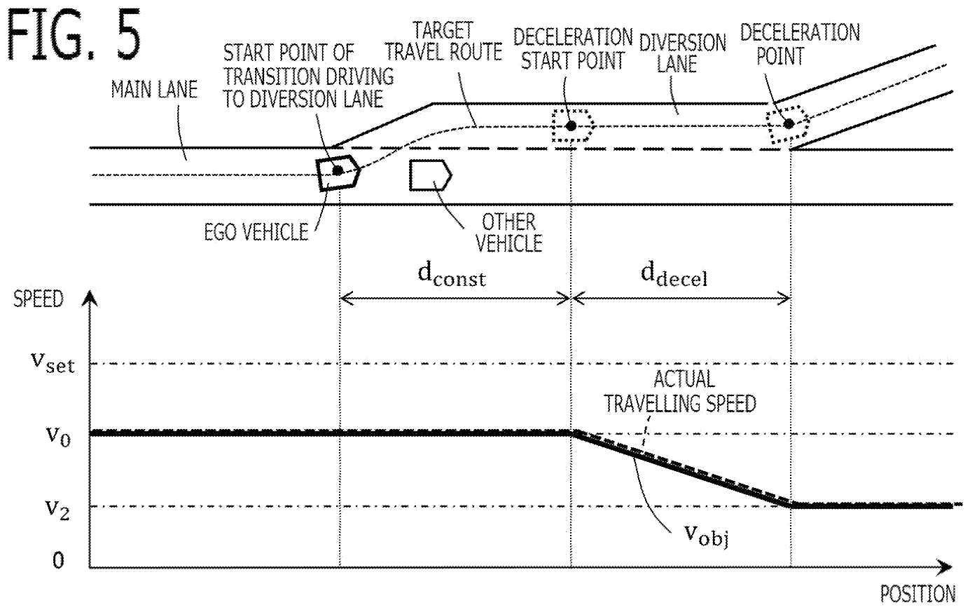

As shown in FIG. 4 and FIG. 5, when the travelling speed of other vehicle which exists in front of the ego vehicle is lower than the speed command value vₛₑₜ, the travelling speed of the ego vehicle becomes lower than the speed command value vₛₑₜ before the start point of transition driving to the diversion lane. Accordingly, if only the ego vehicle changes lanes to the diversion lane, other vehicle followed by the ego vehicle no longer exists, By the normal method, after accelerating from the present travelling speed v₀ to the speed command value vₛₑₜ, the ego vehicle will decelerate to the deceleration point speed v₂. Depending on conditions, the ego vehicle may decelerate immediately after acceleration, and riding comfort is deteriorated. On the other hand, if acceleration is not performed after transiting to the diversion lane, a traveling time to the deceleration point becomes long when a remaining distance l_{fr} of the diversion lane to the deceleration point is long, or when the travelling speed v₀ before transition is low, and riding comfort is deteriorated.

Then, when the diversion lane exists before the deceleration point, after the start point of transition driving to the diversion lane, the target traveling state setting unit 55 sets the target speed v_{obj} based on the speed command value vₛₑₜ, the present travelling speed v₀ of the ego vehicle (in this example, travelling speed v₀ at the start point of transition driving), the remaining distance l_{fr} from the start point of transition driving to the deceleration point, and the deceleration point speed v₂. Also in this case, when other vehicle exists within the determination range in front of the ego vehicle in the diversion lane, the target traveling state setting unit 55 corrects the target speed v_{obj} according to the travelling speed of the other vehicle.

Even when only the ego vehicle transits to the diversion lane in the situation where the ego vehicle is following other vehicle of the travelling speed lower than the speed command value vₛₑₜ in the main lane, the target speed v_{obj} is set based on the speed command value vₛₑₜ, the present travelling speed v₀ of the ego vehicle, the remaining distance l_{fr} from the start point of transition driving to the deceleration point, and the deceleration point speed v₂. Accordingly, the ego vehicle can be prevented from being decelerated immediately after acceleration, and the traveling time to the deceleration point can be prevented from becoming long. And, acceleration and deceleration can be performed appropriately according to the status of the diversion lane, and the status of the ego vehicle, and riding comfort of traveling to the deceleration point can be improved.

The setting processing of the target speed v_{obj} of each point from the start point of transition driving to the diversion lane, to the deceleration point is performed when the transition driving to the diversion lane is started. However, the setting processing may be continuously performed in order to reflect the present status, even after the transition driving to the diversion lane is started.

<Setting of Speed Command Value vₛₑₜ>

The speed command value vₛₑₜ is a speed command value set by the driver or the automated driving function. For example, the target traveling state setting unit 55 increases or decreases the speed command value vₛₑₜ by operation of an input device, such as a switch or a lever, by the driver. Alternatively, the target traveling state setting unit 55 sets the speed command value vₛₑₜ based on the limit speed of the lane, during execution of the automated driving.

### <Setting of Start Point of Transition Driving>

When the lane change is required to transit from the main lane to the diversion lane, the target traveling state setting unit 55 sets a point where an operation of the direction indicator by the driver was detected after the ego vehicle reached at the start point of the diversion lane, as the start point of transition driving to the diversion lane.

When the ego vehicle reached at the start point of the diversion lane, or when the ego vehicle reached at a point before the start point of the diversion lane by a prescribed distance, the target traveling state setting unit 55 may urge an operation of the direction indicator to the driver by the display screen and the loudspeaker.

On the other hand, when the lane change is not required to transit from the main lane to the diversion lane, the target traveling state setting unit 55 sets the start point of the diversion lane, as the start point of transition driving to the diversion lane.

<Calculation of Prediction Traveling Time t_{const}>

The target traveling state setting unit 55 calculates a prediction traveling time t_{const} from the start point of transition driving to the diversion lane, to the deceleration start point, when assuming that the ego vehicle travels according to the speed command value vₛₑₜ.

In the present embodiment, the prediction traveling time t_{const} does not include an acceleration time until reaching the speed command value vₛₑₜ from the present travelling speed v₀ of the ego vehicle. According to this configuration, a time until starting deceleration after acceleration can be evaluated more directly by the prediction traveling time t_{const}, it can be determined whether or not the riding comfort is deteriorated by the acceleration and the deceleration in a short period.

The target traveling state setting unit 55 calculates an acceleration distance d_{accel} until reaching the speed command value vₛₑₜ, based on the speed command value vₛₑₜ, the present travelling speed v₀ of the ego vehicle (in this example, travelling speed v₀ at the start point of transition driving), and the realizable acceleration a_{accel}. In the present embodiment, the next equation is used. Herein, the realizable acceleration a_{accel} is a positive acceleration and is preliminarily set considering the vehicle performance and the riding comfort.

$$[ Math . 2 ]$$

$$1 ) When {v}_{set} > {v}_{0} {d}_{accel} = \frac{{v}_{set}^{2} - {v}_{0}^{2}}{2 {a}_{accel}} \\ 2 ) When {v}_{set} \leq {v}_{0} {d}_{accel} = 0 \qquad ( 2 )$$

The condition 1) of the equation (2) is satisfied, for example, when the travelling speed v₀ of the ego vehicle at the start point of transition driving is lower than the speed command value vₛₑₜ since the ego vehicle was following other vehicle of slow speed during traveling in the main lane. The condition 2) of the equation (2) is satisfied when the ego vehicle was traveling according to the speed command value vₛₑₜ during traveling in the main lane.

The target traveling state setting unit 55 calculates a travel distance d_{const} to be traveled at the speed command value vₛₑₜ, based on the remaining distance l_{fr} from the start point of transition driving to the deceleration point, the acceleration distance d_{accel}, and the deceleration distance d_{decel}. In the present embodiment, the next equation is used. Herein, max (A, B) is a function which outputs any larger one of A and B.

$$[ Math . 3 ]$$

$${d}_{const} = max ( {l}_{fr} - {d}_{accel} - {d}_{decel} , 0 ) \qquad ( 3 )$$

Then, the target traveling state setting unit 55 calculates the prediction traveling time t_{const}, based on the travel distance d_{const} to be traveled at the speed command value vₛₑₜ, and the speed command value vₛₑₜ. In the present embodiment, the next equation is used.

$$[ Math . 4 ]$$

$${t}_{const} = \frac{{d}_{const}}{{v}_{set}} \qquad ( 4 )$$

<Setting of Target Speed v_{obj} to Deceleration Start Point>

As shown in FIG. 4, when the prediction traveling time t_{const} is greater than or equal to a determination time tₜₕ, the target traveling state setting unit 55 sets the speed command value vₛₑₜ as the target speed v_{obj} from the start point of transition driving to the diversion lane, to the deceleration start point.

According to this configuration, when the remaining distance to the deceleration start point is long and the prediction traveling time t_{const} is greater than or equal to the determination time tₜₕ, even if the ego vehicle is decelerated after being accelerated to the speed command value vₛₑₜ, the riding comfort is not deteriorated so much by acceleration and deceleration, and the riding comfort is improved by reducing time until the deceleration is started.

As shown in FIG. 5, when the prediction traveling time t_{const} is less than the determination time tₜₕ, the target traveling state setting unit 55 sets smaller one of the present travelling speed v₀ of the ego vehicle (in this example, travelling speed v₀ at the start point of transition driving), and the speed command value vₛₑₜ, as the target speed v_{obj} from the start point of transition driving to the diversion lane, to the deceleration start point. In the present embodiment, the next equation is used. Herein, min (A, B) is a function which outputs any smaller one of A and B.

$$[ Math . 5 ]$$

$${v}_{obj} = min ( max ( {v}_{0} , {v}_{2} ) , {v}_{set} ) \qquad ( 5 )$$

When the remaining distance to the deceleration start point is short and the prediction traveling time t_{const} becomes less than the determination time tₜₕ, it is necessary to decelerate the ego vehicle immediately after accelerating the ego vehicle to the speed command value vₛₑₜ, and the riding comfort is deteriorated by acceleration and deceleration in a short period. According to the above configuration, since smaller one of the present travelling speed v₀ of the ego vehicle and the speed command value vₛₑₜ is set as the target speed v_{obj}, and the ego vehicle is not accelerated to the speed command value vₛₑₜ, the riding comfort can be prevented from being deteriorated by acceleration and deceleration in the short period.

The prediction traveling time t_{const} may be set to include an acceleration time until reaching the speed command value vₛₑₜ from the present travelling speed v₀ of the ego vehicle. In this case, the determination time tₜₕ is set considering that the acceleration time is included.

<Setting of target speed v_{obj} to Deceleration Point>

The target traveling state setting unit 55 decreases the target speed v_{obj} gradually from the target speed v_{obj} to the deceleration point speed v₂, from the deceleration start point to the deceleration point. For example, it may be decelerated at a prescribed deceleration.

<Setting of Target Speed v_{obj} after Deceleration Point>

The target traveling state setting unit 55 sets the target speed after the deceleration point to the smallest one of the limit speed of road after the deceleration point, the speed command value vₛₑₜ, and the limit speed due to the road curvature after the deceleration point.

As described above, the target traveling state setting unit 55 sets the target speed v_{obj} of each point after the start point of transition driving to the diversion lane. A target acceleration, a target jerk, and the like of each point after the start point of transition driving may be set. The target traveling state setting unit 55 may change the target traveling state in accordance with a periphery state detected by periphery monitoring apparatus 31 and the like.

On the other hand, when the deceleration point, the deceleration point speed v₂, and the deceleration start point are not set, or when the deceleration point, the deceleration point speed v₂, and the deceleration start point are set, but the transition driving to the diversion lane is not started, the target traveling state setting unit 55 sets the target speed v_{obj} of the ego vehicle based on the speed command value vₛₑₜ, as mentioned above.

When other vehicle exists within the determination range in front of the ego vehicle in either case, the target traveling state setting unit 55 corrects the target speed v_{obj} according to the travelling speed of other vehicle.

When the operation of the direction indicator is turned off until the transition to the diversion lane is completed after the operation of the direction indicator was performed by the driver in order to transit from the main lane to the diversion lane, the target traveling state setting unit 55 determines whether the transition to the diversion lane and the deceleration are continued or stopped, based on a completion degree of the transition to the diversion lane; and when determines to be stopped, stops a setting of the target speed v_{obj} for the deceleration.

For example, the target traveling state setting unit 55 determines to continue the transition and the deceleration, when an entry width in the lateral direction of the ego vehicle to the diversion lane is greater than or equal to a determination width; and determines to stop the transition and the deceleration, when the entry width is less than the determination width.

When determining to stop the transition and the deceleration, the target traveling state setting unit 55 sets the target speed v_{obj} based on the speed command value vₛₑₜ, and sets the speed for traveling the main lane.

The target traveling state setting unit 55 may calculate the target steering angle for traveling within the lane or for changing lanes.

### 1-1-6. Vehicle Control Unit 56

In the step S06 of FIG. 3, the vehicle control unit 56 controls the ego vehicle based on the target speed v_{obj}.

In the present embodiment, the vehicle control unit 56 controls the ego vehicle so that the travelling speed of the ego vehicle follows the target speed v_{obj}. For example, the vehicle control unit 56 calculates a command value of the output of the power machine 8, and a command value of the braking force of the electric brake apparatus 9 such that the travelling speed of the ego vehicle follows the target speed v_{obj} of the corresponding position; and transmits each command value to the power controller and the brake controller.

The power controller controls the output of the power machines 8, such as the internal combustion engine and the motor, according to the command value of the output. The brake controller controls the brake operation of the electric brake apparatus 9 according to the command value of the braking force.

The vehicle control unit 56 may transmit the target steering angle and the operation command value of the direction indicator to the automatic steering controller and the light controller. The automatic steering controller controls the electric steering apparatus 7, according to the target steering angle. The light controller controls the direction indicator according to the operation command of the direction indicator.

Various kinds of vehicle control methods may be used. Various kinds of vehicle controls, such as an automated driving and a cruise control, may be performed.

On the other hand, when an accelerator pedal operation, a brake pedal operation, or a handle operation by the driver is detected, the vehicle control unit 56 changes a control amount which is based on the target speed, or ends a control which is based on the target speed, based on operation information. For example, when an acceleration operation is detected by the accelerator pedal operation, the speed command value vₛₑₜ or the target speed v_{obj} is increased. When a deceleration operation is detected by the accelerator pedal operation or the brake pedal operation, the speed command value vₛₑₜ or the target speed v_{obj} is decreased. Alternatively, when an accelerator pedal operating amount, a brake pedal operating amount, or a handle operating amount is greater than or equal to a determination value, the control which is based on the target speed v_{obj} is ended, and is switched to the manual driving by the driver. In this case, the vehicle control unit 56 calculates the command value of the output of the power machine 8, the command value of the braking force of the electric brake apparatus 9, and the target steering angle, based on the accelerator pedal operation, the brake operation, and the handle operation by the driver, and transmits to each controller.

### 2. Embodiment 2

Next, the vehicle control apparatus 50 according to Embodiment 2 will be explained. The explanation for constituent parts the same as those in Embodiment 1 will be omitted. The basic configuration of the vehicle control apparatus 50 according to the present embodiment is the same as that of Embodiment 1. A part of processing of the target traveling state setting unit 55 is different from Embodiment 1.

Similar to Embodiment 1, the target traveling state setting unit 55 calculates a prediction traveling time t_{const} from the start point of transition driving to the diversion lane, to the deceleration start point, when assuming that the ego vehicle travels according to the speed command value vₛₑₜ.

In the present embodiment, when the prediction traveling time t_{const} is less than the determination time tₜₕ, the target traveling state setting unit 55 sets the target speed v_{obj} from the start point of transition driving to the diversion lane, to the deceleration start point so that a prediction traveling time t_{const} from the start point of transition driving to the diversion lane, to the deceleration start point becomes the determination time tₜₕ.

According to this configuration, while suppressing the increase in the traveling time to the deceleration start point, the riding comfort can be prevented from being deteriorated by unnecessary acceleration and deceleration.

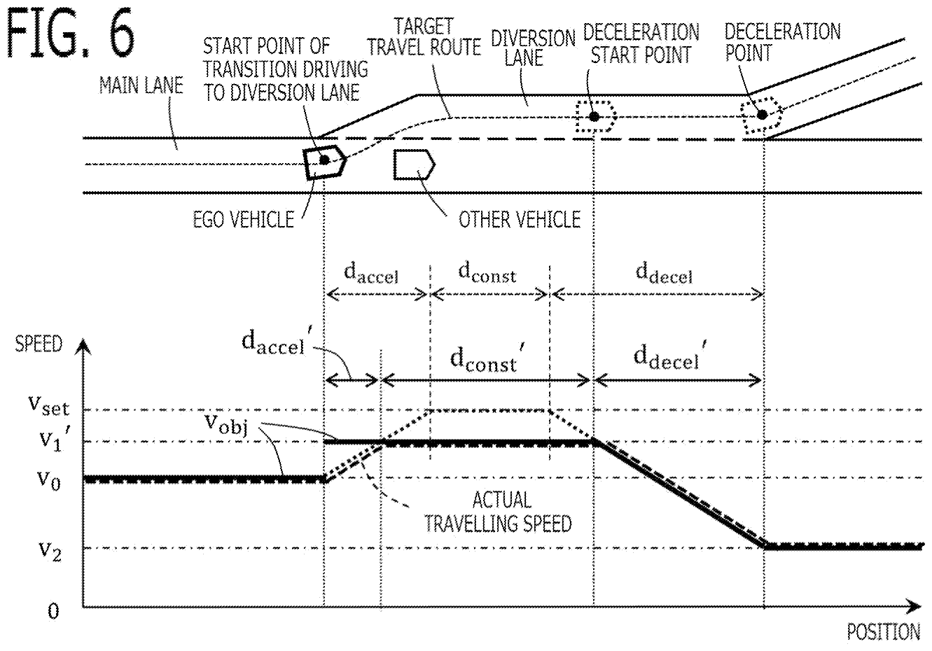

Hereinafter, the setting method of the target speed v_{obj} is explained. As shown in FIG. 6, a speed after adjustment, to the deceleration start point, which is adjusted so that the prediction traveling time t_{const} becomes the determination time tₜₕ is defined as v₁′. An acceleration distance d_{accel}′ after adjustment accelerating by the realizable acceleration a_{accel} from the travelling speed v₀ of the ego vehicle at the start point of transition driving, to the speed v₁′ after adjustment is obtained by the next equation.

$$[ Math . 6 ]$$

$${d}_{accel}^{′} = \frac{{v}_{1}^{′2} - {v}_{0}^{2}}{2 {a}_{accel}} \qquad ( 6 )$$

A deceleration distance d_{decel}′ after adjustment until decelerating by the realizable deceleration a_{decel} from the speed v₁′ after adjustment to the deceleration point speed v₂ is obtained by the next equation.

$$[ Math . 7 ]$$

$${d}_{decel}^{′} = \frac{{v}_{2}^{2} - {v}_{1}^{′2}}{2 {a}_{decel}} \qquad ( 7 )$$

A travel distance d_{const}′ after adjustment obtained by traveling at the speed v₁′ after adjustment until starting deceleration after reaching the speed v₁′ after adjustment is obtained by the next equation. This travel distance d_{const}′ after adjustment may coincide with a distance obtained by multiplying the determination time tₜₕ to the speed v₁′ after adjustment.

$$[ Math . 8 ]$$

$$\begin{matrix}{d}_{const}^{′} = {l}_{fr} - {d}_{accel}^{′} - {d}_{decel}^{′} \\ = {v}_{1}^{′} \cdot {t}_{th}\end{matrix} \qquad ( 8 )$$

The next equation is obtained, when the equation (6) and the equation (7) are substituted for the equation (8) and rearranged. When the quadratic equation of the speed v₁′ after adjustment of the next equation is solved, the speed v₁′ after adjustment can be obtained.

$$[ Math . 9 ]$$

$$( - \frac{1}{2 {a}_{accel}} + \frac{1}{2 {a}_{decel}} ) {v}_{1}^{′2} - {t}_{th} \cdot {v}_{1}^{′} + \frac{{v}_{0}^{2}}{2 {a}_{accel}} - \frac{{v}_{2}^{2}}{2 {a}_{decel}} + {l}_{fr} = 0 \qquad ( 9 )$$

Accordingly, the target traveling state setting unit 55 calculates the speed v₁′ after adjustment based on the determination time tₜₕ, the present travelling speed v₀ of the ego vehicle (in this example, the travelling speed v₀ at the start point of transition driving), the deceleration point speed v₂, and the remaining distance l_{fr} from the start point of transition driving to the deceleration point. The target traveling state setting unit 55 lower-limits the speed v₁′ after adjustment by larger one of the present travelling speed v₀ of the ego vehicle and the deceleration point speed v₂ so that the speed v₁′ after adjustment does not become less than the present travelling speed v₀ and the deceleration point speed v₂ of the ego vehicle.

The deceleration start point setting unit 54 calculates the deceleration distance d_{decel}′ after adjustment, based on the speed v₁′ after adjustment using the equation (7); and sets the deceleration start point to a position before the deceleration point by the deceleration distance d_{decel}′ after adjustment.

The target traveling state setting unit 55 sets the speed v₁′ after adjustment as the target speed v_{obj} from the start point of transition driving to the diversion lane, to the deceleration start point.

The target traveling state setting unit 55 decreases the target speed v_{obj} gradually from the speed v₁′ after adjustment to the deceleration point speed v₂, from the deceleration start point to the deceleration point.

When the prediction traveling time t_{const} is greater than or equal to the determination time tₜₕ, similar to Embodiment 1, the target traveling state setting unit 55 may set the speed command value vₛₑₜ as the target speed v_{obj} from the start point of transition driving to the diversion lane, to the deceleration start point.

### Summary of Aspects of the Present Disclosure

Hereinafter, the aspects of the present disclosure is summarized as appendixes.

### (Appendix 1)

A vehicle control apparatus comprising:
an information acquisition unit that acquires a traveling state of an ego vehicle, road information around the ego vehicle, and information on other vehicle around the ego vehicle;
a target travel route setting unit that sets a target travel route of the ego vehicle;
a deceleration point setting unit that sets a deceleration point which is a point where a speed at which the ego vehicle should travel is less than a present travelling speed of the ego vehicle, on the target travel route, based on the traveling state, the target travel route, and the road information, and sets a deceleration point speed which is a speed at which the ego vehicle should travel at the deceleration point;
a deceleration start point setting unit that sets a deceleration start point which is a point where a deceleration of the ego vehicle is started, between a present position of the ego vehicle and the deceleration point, on the target travel route;
a target traveling state setting unit that sets a target speed; and
a vehicle control unit that controls the ego vehicle based on the target speed,
wherein, when a diversion lane which diverges from a main lane before the deceleration point exists on the target travel route, the deceleration start point setting unit sets the deceleration start point, after a start point of transition driving from the main lane to the diversion lane, and
wherein, when the diversion lane exists before the deceleration point, the target traveling state setting unit sets the target speed of the ego vehicle based on a speed command value, before the start point of transition driving to the diversion lane;
the target traveling state setting unit sets the target speed based on the speed command value, the present travelling speed of the ego vehicle, a remaining distance from the start point of transition driving to the diversion lane, to the deceleration point, and the deceleration point speed, after the start point of transition driving to the diversion lane; and
when other vehicle exists within a determination range in front of the ego vehicle, the target traveling state setting unit corrects the target speed according to the travelling speed of other vehicle.

### (Appendix 2)

The vehicle control apparatus according to Appendix 1,
wherein the deceleration point is a point where the speed at which the ego vehicle should travel switches, and
wherein the deceleration point setting unit sets the deceleration point based on at least one of a switching point of a limit speed, a switching point of a road type, and a switching point of a speed due to a change of road curvature.

### (Appendix 3)

The vehicle control apparatus according to Appendix 1 or 2,
wherein, when a lane change is required to transit from the main lane to the diversion lane, the target traveling state setting unit sets a point where an operation of a direction indicator by a driver was detected after reaching at a start point of the diversion lane, as the start point of transition driving to the diversion lane; and
when the lane change is not required to transit from the main lane to the diversion lane, the target traveling state setting unit sets the start point of the diversion lane, as the start point of transition driving to the diversion lane.

### (Appendix 4)

The vehicle control apparatus according to any one of Appendixes 1 to 3,
wherein the target traveling state setting unit calculates a prediction traveling time from the start point of transition driving to the diversion lane, to the deceleration start point, when assuming that the ego vehicle travels according to the speed command value; and
when the prediction traveling time is less than a determination time, the target traveling state setting unit sets smaller one of the present travelling speed of the ego vehicle and the speed command value, as the target speed from the start point of transition driving to the diversion lane, to the deceleration start point.

### (Appendix 5)

The vehicle control apparatus according to any one of Appendixes 1 to 3,
wherein the target traveling state setting unit calculates a prediction traveling time from the start point of transition driving to the diversion lane, to the deceleration start point, when assuming that the ego vehicle travels according to the speed command value; and
when the prediction traveling time is less than a determination time, the target traveling state setting unit sets the target speed from the start point of transition driving to the diversion lane, to the deceleration start point so that the prediction traveling time from the start point of transition driving to the diversion lane, to the deceleration start point becomes the determination time.

### (Appendix 6)

The vehicle control apparatus according to any one of Appendixes 1 to 5,
wherein the target traveling state setting unit calculates a prediction traveling time from the start point of transition driving to the diversion lane, to the deceleration start point, when assuming that the ego vehicle travels according to the speed command value; and
when the prediction traveling time is greater than or equal to a determination time, the target traveling state setting unit sets the speed command value as the target speed from the start point of transition driving to the diversion lane, to the deceleration start point.

### (Appendix 7)

The vehicle control apparatus according to any one of Appendixes 4 to 6,
wherein the prediction traveling time does not include an acceleration time until reaching the speed command value from the present travelling speed of the ego vehicle.

### (Appendix 8)

The vehicle control apparatus according to any one of Appendixes 4 to 6,
wherein the prediction traveling time includes an acceleration time until reaching the speed command value from the present travelling speed of the ego vehicle.

### (Appendix 9)

The vehicle control apparatus according to any one of Appendixes 1 to 8,
wherein the target traveling state setting unit sets the target speed after the deceleration point, to the smallest one of a limit speed of road after the deceleration point, the speed command value, and a limit speed due to a road curvature after the deceleration point.

### (Appendix 10)

The vehicle control apparatus according to any one of Appendixes 1 to 9,
wherein, when an accelerator pedal operation, a brake pedal operation, or a handle operation by a driver is detected, the vehicle control unit changes a control amount which is based on the target speed, or ends a control which is based on the target speed, based on operation information.

### (Appendix 11)

The vehicle control apparatus according to any one of Appendixes 1 to 10,
wherein, when an operation of a direction indicator is turned off until a transition to the diversion lane is completed after the operation of the direction indicator was performed by a driver in order to transit from the main lane to the diversion lane, the target traveling state setting unit determines whether the transition to the diversion lane and a deceleration are continued or stopped, based on a completion degree of the transition to the diversion lane; and
when determines to be stopped, the target traveling state setting unit stops a setting of the target speed for deceleration.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A vehicle control apparatus comprising at least one processor configured to implement:
an information acquisitor that acquires a traveling state of an ego vehicle, road information around the ego vehicle, and information on other vehicle around the ego vehicle;
a target travel route setter that sets a target travel route of the ego vehicle;
a deceleration point setter that sets a deceleration point which is a point where a speed at which the ego vehicle should travel is less than a present travelling speed of the ego vehicle, on the target travel route, based on the traveling state, the target travel route, and the road information, and sets a deceleration point speed which is a speed at which the ego vehicle should travel at the deceleration point;
a deceleration start point setter that sets a deceleration start point which is a point where a deceleration of the ego vehicle is started, between a present position of the ego vehicle and the deceleration point, on the target travel route;
a target traveling state setter that sets a target speed; and
a vehicle controller that controls the ego vehicle based on the target speed,
wherein, when a diversion lane which diverges from a main lane before the deceleration point exists on the target travel route, the deceleration start point setter sets the deceleration start point, after a start point of transition driving from the main lane to the diversion lane, and
wherein, when the diversion lane exists before the deceleration point, the target traveling state setter sets the target speed of the ego vehicle based on a speed command value, before the start point of transition driving to the diversion lane;
the target traveling state setter sets the target speed based on the speed command value, the present travelling speed of the ego vehicle, a remaining distance from the start point of transition driving to the diversion lane, to the deceleration point, and the deceleration point speed, after the start point of transition driving to the diversion lane; and
when other vehicle exists within a determination range in front of the ego vehicle, the target traveling state setter corrects the target speed according to the travelling speed of other vehicle.

2. The vehicle control apparatus according to claim 1,
wherein the deceleration point is a point where the speed at which the ego vehicle should travel switches, and
wherein the deceleration point setter sets the deceleration point based on at least one of a switching point of a limit speed, a switching point of a road type, and a switching point of a speed due to a change of road curvature.

3. The vehicle control apparatus according to claim 1,
wherein, when a lane change is required to transit from the main lane to the diversion lane, the target traveling state setter sets a point where an operation of a direction indicator by a driver was detected after reaching at a start point of the diversion lane, as the start point of transition driving to the diversion lane; and
when the lane change is not required to transit from the main lane to the diversion lane, the target traveling state setter sets the start point of the diversion lane, as the start point of transition driving to the diversion lane.

4. The vehicle control apparatus according to claim 1,
wherein the target traveling state setter calculates a prediction traveling time from the start point of transition driving to the diversion lane, to the deceleration start point, when assuming that the ego vehicle travels according to the speed command value; and
when the prediction traveling time is less than a determination time, the target traveling state setter sets smaller one of the present travelling speed of the ego vehicle and the speed command value, as the target speed from the start point of transition driving to the diversion lane, to the deceleration start point.

5. The vehicle control apparatus according to claim 1,
wherein the target traveling state setter calculates prediction traveling time from the start point of transition driving to the diversion lane, to the deceleration start point, when assuming that the ego vehicle travels according to the speed command value; and
when the prediction traveling time is less than a determination time, the target traveling state setter sets the target speed from the start point of transition driving to the diversion lane, to the deceleration start point so that the prediction traveling time from the start point of transition driving to the diversion lane, to the deceleration start point becomes the determination time.

6. The vehicle control apparatus according to claim 1,
wherein the target traveling state setter calculates a prediction traveling time from the start point of transition driving to the diversion lane, to the deceleration start point, when assuming that the ego vehicle travels according to the speed command value; and
when the prediction traveling time is greater than or equal to a determination time, the target traveling state setter sets the speed command value as the target speed from the start point of transition driving to the diversion lane, to the deceleration start point.

7. The vehicle control apparatus according to claim 4,
wherein the prediction traveling time does not include an acceleration time until reaching the speed command value from the present travelling speed of the ego vehicle.

8. The vehicle control apparatus according to claim 4,
wherein the prediction traveling time includes an acceleration time until reaching the speed command value from the present travelling speed of the ego vehicle.

9. The vehicle control apparatus according to claim 1,
wherein the target traveling state setter sets the target speed after the deceleration point, to the smallest one of a limit speed of road after the deceleration point, the speed command value, and a limit speed due to a road curvature after the deceleration point.

10. The vehicle control apparatus according to claim 1,
wherein, when an accelerator pedal operation, a brake pedal operation, or a handle operation by a driver is detected, the vehicle controller changes a control amount which is based on the target speed, or ends a control which is based on the target speed, based on operation information.

11. The vehicle control apparatus according to claim 1,
wherein, when an operation of a direction indicator is turned off until a transition to the diversion lane is completed after the operation of the direction indicator was performed by a driver in order to transit from the main lane to the diversion lane, the target traveling state setter determines whether the transition to the diversion lane and a deceleration are continued or stopped, based on a completion degree of the transition to the diversion lane; and
when determines to be stopped, the target traveling state setter stops a setting of the target speed for deceleration.

12. A vehicle control method that makes an arithmetic processor perform each following step, the vehicle control method comprising:
an information acquisition step of acquiring a traveling state of an ego vehicle, road information around the ego vehicle, and information on other vehicle around the ego vehicle;
a target travel route setting step of setting a target travel route of the ego vehicle;
a deceleration point setting step of setting a deceleration point which is a point where a speed at which the ego vehicle should travel is less than a present travelling speed of the ego vehicle, on the target travel route, based on the traveling state, the target travel route, and the road information, and setting a deceleration point speed which is a speed at which the ego vehicle should travel at the deceleration point;
a deceleration start point setting step of setting a deceleration start point which is a point where a deceleration of the ego vehicle is started, between a present position of the ego vehicle and the deceleration point, on the target travel route;
a target traveling state setting step of setting a target speed; and
a vehicle control step of controlling the ego vehicle based on the target speed,
wherein, in the deceleration start point setting step, when a diversion lane which diverges from a main lane before the deceleration point exists on the target travel route, setting the deceleration start point after a start point of transition driving from the main lane to the diversion lane, and
wherein, in the traveling state setting step, when the diversion lane exists before the deceleration point, setting the target speed of the ego vehicle based on a speed command value, before the start point of transition driving to the diversion lane;
setting the target speed based on the speed command value, the present travelling speed of the ego vehicle, a remaining distance from the start point of to the diversion lane, to the deceleration point, and the deceleration point speed, after the start point of transition driving to the diversion lane; and
when other vehicle exists within a determination range in front of the ego vehicle, correcting the target speed according to the travelling speed of other vehicle.
